(19) United States
(12) Patent Application Publication
(10) Pub. No.: US 2023/0186980 A1
(43) Pub. Date: Jun. 15, 2023

(54) SYNTHESIZABLE LOGIC MEMORY

(71) Applicant: GlobalFoundries U.S. Inc., Malta, NY (US)

(72) Inventors: Gregory A. Northrop, Everett, WA (US); Vivek Raj, Bangalore (IN); Amlan Bag, Bangalore (IN); Shashank Nemawarkar, Austin, TX (US)

(21) Appl. No.: 17/546,408

(22) Filed: Dec. 9, 2021

(51) Int. Cl. G11C 11/419; G06F 30/327; G06F 30/3315

(52) U.S. Cl. CPC G11C 11/419; G06F 30/327; G06F 30/3315; G11C 11/412

(57) ABSTRACT

Embodiments of the present disclosure provide a method for forming a memory, including: forming a memory core using a plurality of cells from a library of cells, wherein each cell in the library of cells follows standard cell row placement constraints and includes a static timing model, and wherein the plurality of cells includes a dynamic bitcell; wherein forming the memory core further includes connecting a plurality of the bitcells via abutment to form a rectangular array of bitcells such that bitlines of the bitcells and wordlines of the bitcells connect by abutment and are shared between adjacent bitcells in the array of bitcells.

### TECHNICAL FIELD

Embodiments of the disclosure relate generally to memory circuits. More specifically, the disclosure provides a set of cells for a memory array (e.g., a static random-access memory (SRAM)) that follows standard cell placement constraints and which supports static timing models at the bitcell level.

### BACKGROUND

Integrated circuit designs commonly utilize SRAM for storing large amounts of data and register files for storing small bit counts. Each of these approaches, however, is suboptimal in area and power requirements when implementing memories with intermediate storage requirements (e.g., a few hundred bytes to a few thousand bytes). For example, register files typically require a substantial amount of area compared to a standard bit cell, while SRAMs require a substantial amount of peripheral logic.

### SUMMARY

Aspects of the disclosure provide a method for forming a memory, including: forming a memory core using a plurality of cells from a library of cells, wherein each cell in the library of cells follows standard cell row placement constraints and includes a static timing model, and wherein the plurality of cells includes a dynamic bitcell; wherein forming the memory core further includes connecting a plurality of the bitcells via abutment to form a rectangular array of bitcells such that bitlines of the bitcells and wordlines of the bitcells connect by abutment and are shared between adjacent bitcells in the array of bitcells.

Another aspect of the disclosure provides a static random-access memory (SRAM), including: a memory core formed using a plurality of cells in a library of cells, wherein each cell in the library of cells follows standard cell row placement constraints and includes a static timing model, and wherein the plurality of cells in the library of cells includes a dynamic bitcell; wherein the memory core comprises a plurality of the bitcells connected via abutment to form a rectangular array of bitcells such that wordlines and bitlines of abutting bitcells in the array of bitcells connect by abutment and are shared between adjacent bitcells in the array of bitcells.

A further aspect of the disclosure is directed to a method for designing a memory, including: defining a register transfer level (RTL) memory design including a plurality of cells, wherein the plurality of cells are provided in a library of cells and follow standard cell row placement constraints, and wherein the plurality of cells includes: a dynamic bitcell; a wordline driver; a bitline write cell; a bitline read cell; and a peripheral cell; and providing a static timing model for each of the plurality of cells in the library of cells.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure.

FIG. 1 depicts a synthesizable logic memory (SLM) library including at least one set of leaf cells according to embodiments of the disclosure.

FIG. 2 depicts a 1R1W bitcell that may be formed using the cells in the SLM library of FIG. 1 according to embodiments of the disclosure.

FIG. 3 depicts a 2R1W bitcell that may be formed using the cells in the SLM library according to embodiments of the disclosure.

FIG. 4 depicts an example of an SRAM core formed using a set of cells in the SLM library of FIG. 1 according to embodiments of the disclosure.

FIG. 5 depicts an example of the ordering attributes that drive the correct placement of the cells in the SRAM core of FIG. 4.

FIG. 6 depicts a portion of the SRAM core of FIG. 4 showing how bitlines and wordlines in each bitcell may be shared between abutting bitcells according to embodiments of the disclosure.

FIG. 7 depicts the SRAM core of FIG. 4 with a plurality of peripheral cells to according to embodiments of the disclosure, and control circuitry implemented using standard cells of a standard cell library.

FIG. 8 depicts a primary SLM design flow according to embodiments of the disclosure.

FIG. 9 depicts an example of the netlist connectivity provided during synthesis of several abutting cells of the SLM library.

FIG. 10 depicts the abutting placement of the cells of the SLM library shown in FIG. 9.

FIG. 11 depicts the SLM design flow of FIG. 8 further including an optional timing analysis according to embodiments of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

A standard cell library is a collection of well-defined and appropriately characterized logic gates that can be used to implement a digital design. Standard cells must meet predefined specifications to be manipulated by synthesis, place, and route algorithms. In practice, a standard cell library is delivered with a collection of files that provide all the information needed by various electronic design automation (EDA) tools. Such information typically includes timing (e.g., static timing) and power parameters obtained by simulating the cells under a variety of conditions. The timing and power parameters are provided in the industry standard Liberty (.lib) format, where a .lib file is an ASCII representation of the timing and power parameters (e.g., cell delay, cell transition time, and setup and hold time requirement) associated with the cells in a standard cell library of a particular technology.

Standard cells in a standard cell library can be used to form SRAM-like functional arrays (address in, clock in, data word in (write) or out (read)), where the fundamental storage element is a latch (broken feedback) with a pair of latches forming a flip-flop. However, standard cells cannot be used to form a storage element in an SRAM (e.g., an inverter pair latch (no broken feedback)), where writing is done by over-riding the feedback in the latch directly through the write bitlines.

When designing an integrated circuit, application specific integrated circuit (ASIC), or system on a chip (SoC) including an SRAM, the SRAM is often generated using a memory compiler. A memory compiler is a computer program which can synthesize different, typically general, memory configurations. A memory compiler is configured to generate memory related design files based on design specifications. The design files are used for synthesis, function simulation, verification, layout, floor planning, placement, and routing. A memory compiler provides a static timing model for the entire SRAM which allows the SRAM to be used in a static timing and simulation environment.

An SRAM provided by a memory compiler is typically designed for general use and tends to lack the customization required to match the specific design requirements of an integrated circuit, ASIC, or SoC design. For example, a standard memory compiler is not capable of providing an SRAM that supports multiple reads or writes (e.g., an SRAM with more than one read or write port).

According to embodiments of the disclosure, a synthesizable logic memory (SLM) library is provided which allows fine grain modeling and customization of an SRAM at the bitcell level. The SLM library includes a set of cells that may be tiled commensurately within a standard cell design to form the core of an SRAM, following logic ground rules. Each cell in the set of cells in the SLM library includes its own static timing model, which is provided to a static timing engine, just as with standard cells.

All of the cells in a standard cell library follow the same row placement constraints, namely, the cells in a standard cell library have a fixed size in one dimension (the row height or track size of the library) and are variable in the other dimension (but in integer multiples of a key technology parameter, usually a device or wire pitch). Such row placement constraints simplify the placement problem of the cells of the standard cell library into a discreet matrix of points defined by the row height in one dimension (Y) and the other placement pitch parallel to the row. According to embodiments of the disclosure, the cells in the SLM library follow the same row placement constraints as the cells in a standard cell library, which allows the cells in the standard cell library to be placed in a larger design formed using cells from a standard cell library.

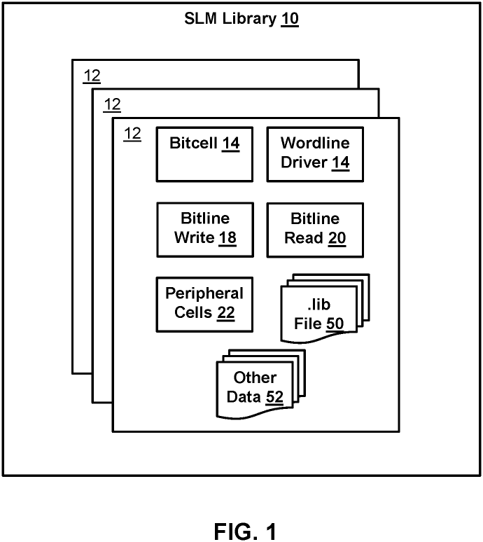

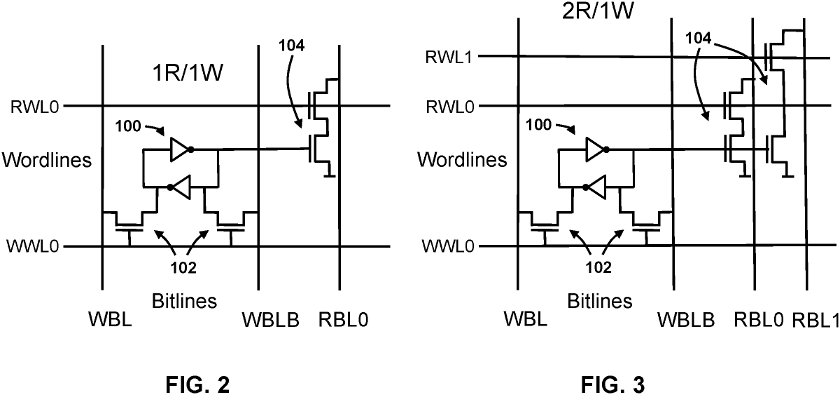

FIG. 1 depicts a synthesizable logic memory (SLM) library 10 including at least one set 12 of leaf cells (hereafter generally referred to as “cells”) according to embodiments of the disclosure. Each set 12 of cells in the SLM library 10 may be used to form a different SRAM port configuration including, for example, a single port SRAM (1R1W) (FIG. 2) that allows a single read or write at a time, a two port SRAM (2R1W) (FIG. 3) that allows multiple reads or writes to occur at the same time, etc. In the 1R1W SRAM of FIG. 2 and the 2R1W SRAM of FIG. 3, the storage element includes an inverter pair latch 100, the write path includes true/comp bitlines WBL/WBLB and pass transistors 102, similar to a conventional SRAM, while each read port includes a single bitline RBL0, RBL1 with dynamic precharge and full swing through series FETs 104.

According to embodiments, each set 12 of cells in the SLM library 10 may include a dynamic bitcell 14 for storing a bit of data (hereafter “bitcell 14”), a wordline driver cell 16 for accessing (e.g., reading/writing) the bitcell 14, a bitline write cell 18 for writing data to the bitcell 14, and a bitline read cell 20 for reading data from the bitcell 14. Unlike a bitcell in a standard cell library, the bitcell 14 uses dynamic circuit techniques when reading/writing data (e.g., the bitcell 14 includes a dynamic precharge bitline). Each set 12 of cells in the SLM library 10 may also include various peripheral cells 22 required for standard cell abutment at the edge of a memory core formed using the bitcells 14, wordline driver cells 16, bitline write cells 18, and bitline read cells 20.

According to embodiments, the physical image of each of the cells in the SLM library 10 is completely compatible with standard cells in a chosen standard cell library (hereafter “standard cell library”). That is, the SLM library 10 can be considered to be an extension to the standard cell library. However, the internal structure of each of the cells in the SLM library 10 is tailored for use in custom SRAMs in a way that cannot be provided using standard cells in a standard cell library. For example, the wordline and bitline metal contacts (wires) in the bitcells 14 connect by abutment when placed and are shared between adjacent bitcells 14. This type of abutment is not allowed in standard cell libraries because, for example, cell to cell connectivity needs to be independent of placement in conventional standard cell design. Connectivity by abutment presumes connectivity between neighbors.

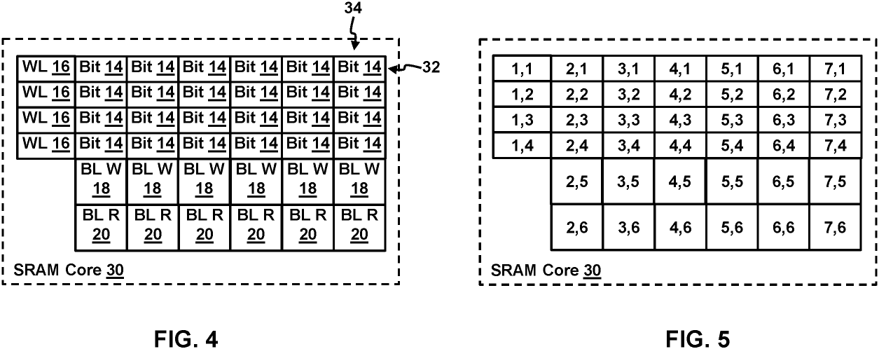

An example of an SRAM core 30 formed using a set 12 of cells in the SLM library 10 is depicted in FIG. 4. As shown, the core 30 may include a rectangular array of bitcells 14 that follow standard cell placement (row) constraints. An example of the ordering attributes that drive the correct placement of the cells in the SRAM core 30 of FIG. 4 is depicted in FIG. 5. Placement constraints (e.g., data path or relative placement) require an abutted regular placement of the components of the SRAM core 30, while allowing optimization of the overall placement of the SRAM core 30 in a larger design. For example, a placement tool will keep the cells of the SRAM core 30 close to each other since they have strong connectivity between them. While doing that, the placement tool will usually pick a good place for the cells of the SRAM core 30 in a larger design, which is generally much larger.

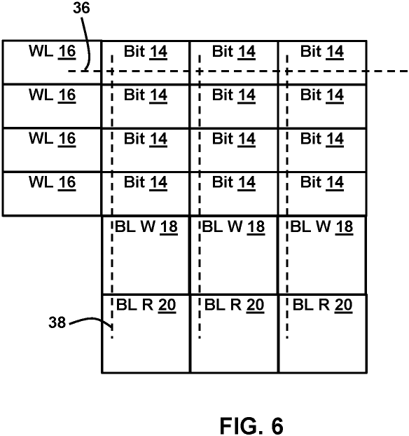

In the SRAM core 30, the bitcells 14 are connected by abutment. A wordline driver cell 16 is placed in abutment with each row 32 of bitcells 14. A bitline write cell 18 and a bitline read cell 20 are placed in abutment with each other and one of the bitline write cell 18 or bitline read cell 20 is placed in abutment with each column 34 of bitlines 14. FIG. 6 depicts a portion of the SRAM core 30 of FIG. 4 showing how wordlines 36 and bitlines 38 may be shared between abutting bitcells 14.

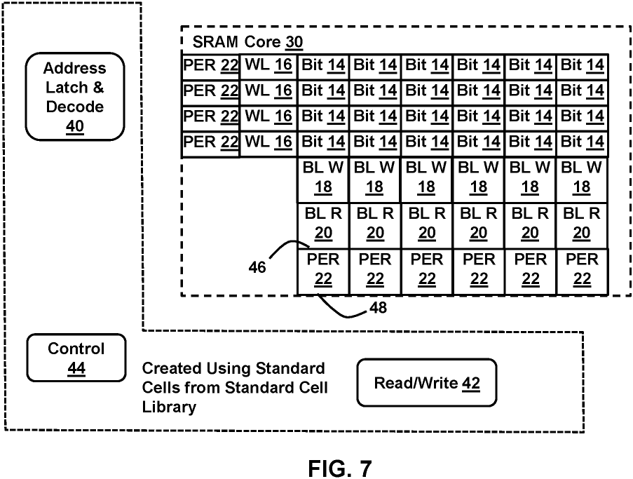

In FIG. 7, the SRAM core 30 is depicted as further including a plurality of peripheral cells 22. The peripheral cells 22 allow various outer cells of the SRAM core 30 (e.g., wordline driver cell 16, bitline write cell 18, bitline read cell 20) to be connected to control circuitry, external to the SRAM core 30, created by synthesis using standard cells of a standard cell library. Such control circuitry may include, for example, address latch and decoding circuitry 40 for generating bitline signals and read/write circuitry 42 for reading from and writing data to bitcells 14 in the SRAM core 30, and other applicable control circuitry 44. The inner boundary 46 of each peripheral cell 22 is connected via abutment to a corresponding cell (e.g., wordline driver cell 16, bitline write cell 18, bitline read cell 20) in the SRAM core 30. The outer boundary 48 of each peripheral cell 22, however, is compatible with the standard cells of the standard cell library. To this extent, in general, the peripheral cells 22 provide an interface between the cells in the SLM library 10 and standard cells in a standard cell library.

The SRAM core 30 may be instantiated directly in a register transfer level (RTL) design, which is preserved through synthesis, and compiled using a standard digital logic design flow. A hardware design language such as Verilog may be used to write the RTL design of the SLM core 30. The RTL design of the SRAM core 30 includes a direct instantiation of:
a) an N wordline by M bitline array of bitcells 14;
b) N wordline driver cells 16;
c) M bitline read cells 18;
d) M bitline write cells 20; and
e) Peripheral cells 22.

The RTL design also includes soft logic, created by synthesis using standard cells of a standard cell library, to map wordline and bitline signals into memory address (decode) and data read/write (ports). The remaining functions for a memory (e.g., decode, multiplexing, controls, etc.) may also be written in RTL and created by synthesis using standard cells of a standard cell library.

According to embodiments, timing and power models are provided (e.g., in a .lib format) for each individual cell in the SLM library 10 to support static timing and power analysis of an SRAM core 30 formed using the cells in the SLM library 10. The .lib file(s) 50 (FIG. 1) are provided as part of the SLM library 10. The timing and power models may be provided using a tool such as the Liberate characterization tool available from Cadence. This may include running circuit simulation(s) to evaluate the delay and power usage of the read and write paths through a bitcell 14 and similar paths through each wordline driver cell 16, bitline read cell 18, bitline write cell 20, and peripheral cell 22. The performance values (e.g., timing arcs) are captured into a static timing model for each cell in the SLM library 10. Advantageously, the generation of a separate timing model for each cell in the SLM library 10 allows a static timing tool used in logic synthesis to time and otherwise characterize the entire design (memory and logic) in situ.

The SLM library 10 (FIG. 1) may also include various other data 52, including layout, schematic, symbol, abstract, and/or other logical or simulation views for each cell in the SLM library 10. From this, various information may be captured in a number of formats (e.g., in a Library Exchange Format (LEF) representing the physical layout in an ASCII format).

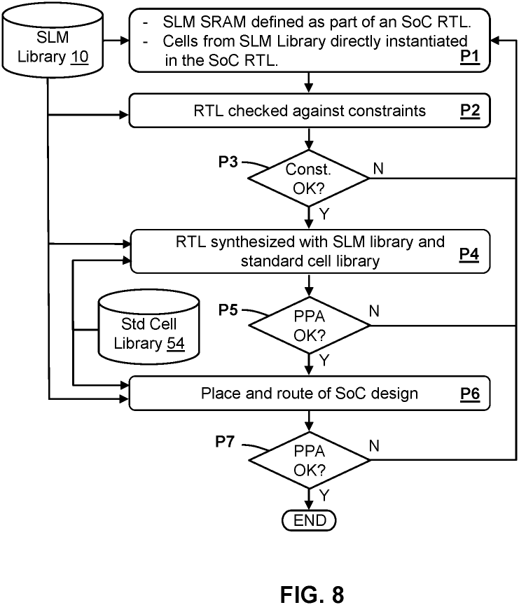

An SLM design flow according to embodiments is depicted in FIG. 8, described with reference to FIG. 7.

At process P1, the cells forming an SRAM core 30 are defined in RTL as a part of a larger SoC RTL design. The RTL for the cells forming the SRAM core 30 is written in an HDL such as Verilog. The particular cells selected for the SRAM core 30 may depend on the available architectures supported by the SLM library 10 (e.g., port configuration, bitcell type, etc.). The cells of the SRAM core (e.g., bitcells 14, wordline driver cells 16, bitline write cells 18, bitline read cells 20, peripheral cells 22) are directly instantiated in RTL in the SoC RTL design.

At process P2, the RTL for the cells of the SRAM core 30 is checked against design constraints (e.g., core size, maximum dimensions, allowed periphery types, etc.). If the design constraints are met (Y at process P3), flow passes to process P4. If not (N at process P3), flow passes back to process P1, where the SoC/SRAM RTL design may be modified accordingly.

At process P4, the SoC RTL design is synthesized using the cells in the SLM library 10 and the standard cells of the standard cell library 54. This process includes static timing analysis based on the timing models provided in the .lib files 50 for each cell in the SLM library 10 and timing models provided for standard cells in the standard cell library 54. If the power, performance, and area requirements (PPA) for the SoC design are acceptable (Y at process P5), flow passes to process P6, where placement and routing of the SoC design is performed. If the power, performance, and area requirements are not acceptable (N at process P5), flow passes back to process P1, where the SoC/SRAM RTL design may be modified accordingly.

In general, during placement, the SRAM core 30 may be placed freely within a larger design as long as the cells of the SRAM core 30 remain appropriately abutted. Placement of the soft logic required to obtain memory addresses and the port configuration from the wordline and bitline signals, however, may be optimized in a conventional manner.

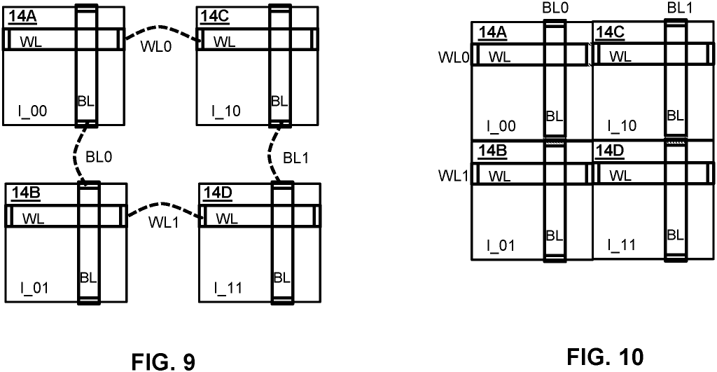

FIG. 9 depicts an example of the netlist connectivity provided during synthesis of several abutting cells (e.g., bitcells 14A, 14B, 14C, and 14D) of the SRAM core 30, where the dashed lines are connecting nets (e.g., wordlines WL0, WL1, and bitlines BL0, BL1). In general, in accordance with ordering attributes (e.g., l_00, l_01, l_10, l_11) of the bitcells 14A, 14B, 14C, and 14D, placement strives to place the bitcells 14A, 14B, 14C, and 14D such that the length of the nets is minimized. As shown FIG. 10, for example, when properly placed, the bitlines BL of the bitcells 14A and 14B and the bitlines BL of the bitcells 14C and 14D connect via abutment to form bitlines BL0, BL1, respectively. Similarly, the wordlines WL of the bitcells 14A and 14C and the wordlines WL of the bitcells 14B and 14D connect via abutment to form wordlines WL0, WL1, respectively. Any other ordering of the bitcells 14A, 14B, 14C, and 14D would result in shorts between the bitlines and/or wordlines.

After placement and routing of the SoC design has been completed in process P6, the power, performance, and area requirements for the SoC design are again examined at process P7. If acceptable (Y at process P5), the process ends. If the power, performance, and area requirements (PPA) for the SoC design are not acceptable (N at process P7), flow passes back to process P1, where the where the SoC/SRAM RTL design may be modified accordingly.

In the SLM design flow depicted in FIG. 8, the SLM library 10 provides various data/views, including, for example:
a) Process P1 - RTL written in Verilog;
b) Process P2 - Design Constraints (e.g., SRAM core size, periphery choices);
c) Process P4 - Front end of the line (FEOL) views (e.g., Verilog, timing models (.lib), LEF); and
d) Process P6 - FEOL and back end of the line (BEOL) views, relative placement constraints.

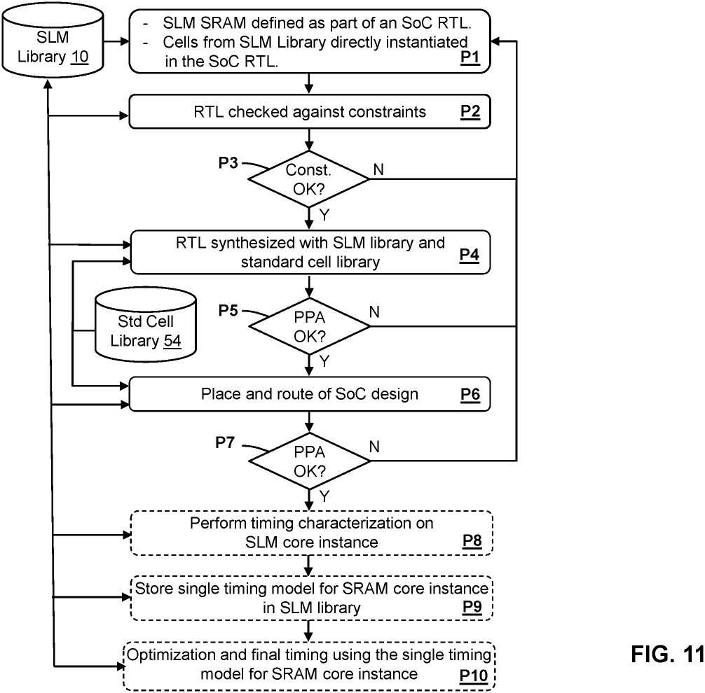

Upon completion of the SLM design flow depicted in FIG. 8, an optional timing analysis may be performed as shown in phantom in FIG. 11. The optional timing analysis includes a process P8, where a timing characterization is run on the SRAM core 30 in the SoC design to provide a single timing model for the SRAM core 30 in the SoC design, and a process P9, where the single timing model for the SRAM core 30 is stored in the SLM library 10. Subsequently, at process P10, late optimization and final timing may be performed on the SoC design using the single timing model for the SRAM core 30. Advantageously, by using a single, large timing model for the SLM core 30 instead of a hierarchical collection of individual, cell-level timing models, the time required for static timing may be reduced and the accuracy of the static timing may be improved.

Embodiments of the disclosure provide various technical and commercial advantages, examples of which have been described above. Additional technical and commercial advantages are discussed below. For example, embodiments of the disclosure provide an SLM library 10 including a plurality of sets 12 of cells for providing SRAM cores 30 having multiple different port configurations, including, for example, a two port SRAM (2R1W) that allows multiple reads or writes to occur at the same time.

An SRAM core 30 formed using the cells in the SLM library 10 can be quickly designed via RTL, without the overhead of compiling and floor-planning instances and can be easily modified by rewriting the RTL. For smaller sizes of SRAMs, the processes described herein are more area/power efficient than other techniques used to form SRAMs (e.g., register files). In addition, an SRAM core 30 formed using the cells in the SLM library 10 can be more efficiently integrated into other logic, including automated placement and synthesis optimization of PPA for the support logic for the SRAM core 30.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As used herein, the term “configured,” “configured to” and/or “configured for” can refer to specific-purpose patterns of the component so described. For example, a system or device configured to perform a function can include a computer system or computing device programmed or otherwise modified to perform that specific function. In other cases, program code stored on a computer-readable medium (e.g., storage medium), can be configured to cause at least one computing device to perform functions when that program code is executed on that computing device. In these cases, the arrangement of the program code triggers specific functions in the computing device upon execution. In other examples, a device configured to interact with and/or act upon other components can be specifically shaped and/or designed to effectively interact with and/or act upon those components. In some such circumstances, the device is configured to interact with another component because at least a portion of its shape complements at least a portion of the shape of that other component. In some circumstances, at least a portion of the device is sized to interact with at least a portion of that other component. The physical relationship (e.g., complementary, size-coincident, etc.) between the device and the other component can aid in performing a function, for example, displacement of one or more of the devices or other components, engagement of one or more of the devices or other components, etc.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for forming a memory, comprising:
forming a memory core using a plurality of cells from a library of cells, wherein each cell in the library of cells follows standard cell row placement constraints and includes a static timing model, and wherein the plurality of cells includes a dynamic bitcell;
wherein forming the memory core further includes connecting a plurality of the bitcells via abutment to form a rectangular array of bitcells such that bitlines of the bitcells and wordlines of the bitcells connect by abutment and are shared between adjacent bitcells in the array of bitcells.

2. The method of claim 1, wherein forming the memory core further comprises:
connecting each row of bitcells in the array of bitcells via abutment with a respective wordline driver cell; and
connecting each column of bitcells in the array of bitcells via abutment with a respective bitline write cell or a respective bitline write cell.

3. The method of claim 1, wherein the memory core further comprises a plurality of peripheral cells, wherein an outer boundary of each peripheral cell is compatible with standard cells of a standard cell library.

4. The method of claim 3, further comprising:
forming control circuitry for the memory core using a plurality of the standard cells of the standard cell library; and
connecting the control circuitry to the memory core via the plurality of peripheral cells.

5. The method of claim 1, further comprising providing the timing model for each cell in the library of cells by evaluating a delay and power usage through each cell in the library of cells.

6. The method of claim 1, further comprising creating a single timing model for the memory core.

7. A static random-access memory (SRAM), comprising:
a memory core formed using a plurality of cells in a library of cells, wherein each cell in the library of cells follows standard cell row placement constraints and includes a static timing model, and wherein the plurality of cells in the library of cells includes a dynamic bitcell;
wherein the memory core comprises a plurality of the bitcells connected via abutment to form a rectangular array of bitcells such that wordlines and bitlines of abutting bitcells in the array of bitcells connect by abutment and are shared between adjacent bitcells in the array of bitcells.

8. The SRAM of claim 7, wherein the memory core further comprises:
a wordline driver cell in abutment with each respective row of bitcells in the array of bitcells;
a bitline write cell and a bitline read cell in abutment with each other, wherein one of the bitline write cell or the bitline read cell is in abutment with each respective column of bitcells in the array of bitcells.

9. The SRAM of claim 8, wherein the memory core further comprises a plurality of peripheral cells, wherein an outer boundary of each peripheral cell is compatible with standard cells of a standard cell library.

10. The SRAM of claim 9, further comprising control circuitry for the memory core, formed using standard cells of the standard cell library, wherein the control circuitry is connected to the memory core via the plurality of peripheral cells.

11. A method for designing a memory, comprising:
defining a register transfer level (RTL) memory design including a plurality of cells, wherein the plurality of cells are provided in a library of cells and follow standard cell row placement constraints, and wherein the plurality of cells includes: a dynamic bitcell; a wordline driver; a bitline write cell; a bitline read cell; and a peripheral cell; and
providing a static timing model for each of the plurality of cells in the library of cells.

12. The method of claim 11, wherein each of the plurality of cells in the RTL memory design is directly instantiated in RTL.

13. The method of claim 11, further comprising:
forming a memory core in the RTL memory design by placing a plurality of the bitcells to form a rectangular array of bitcells, wherein the bitcells in the rectangular array connect via abutment.

14. The method of claim 13, wherein bitlines and wordlines of the memory core connect by abutment and are shared between adjacent bitcells in the array of bitcells.

15. The method of claim 13, wherein forming the memory core in the RTL memory design further comprises:
placing an instance of the wordline driver cell in abutment with each row of bitcells in the array of bitcells;
placing an instance of the bitline write cell in abutment with each column of bitcells in the array of bitcells;
placing an instance of the bitline read cell in in abutment with each instance of the bitline write cell; and
placing an instance of the peripheral cell in abutment with each instance of the wordline driver cell and in abutment with each instance of the bitline read cell, wherein an outer boundary of each instance of the peripheral cell is compatible with standard cells of a standard cell library.

16. The method of claim 13, wherein forming the memory core in the RTL memory design further comprises:
forming control circuitry for the memory core using standard cells of the standard cell library; and
connecting the control circuitry to the memory core via a plurality of instances of the peripheral cells.

17. The method of claim 13, wherein providing the timing model further comprises:
evaluating a delay and power usage of read and write paths through each bitcell in the array of bitcells; and
creating a timing model for each bitcell in the array of bitcells.

18. The method of claim 13, further comprising creating a single timing model for the memory core.

19. The method of claim 16, further comprising synthesizing the RTL memory design with the cells in the library of cells and the standard cells in the standard cell library.

20. The method of claim 11, wherein the bitcell includes a precharge bitline.
